(19) United States
(12) Patent Application Publication
(10) Pub. No.: US 2012/0310743 A1
(43) Pub. Date: Dec. 6, 2012

(54) Using mobile devices to make secure and reliable payments for store or online purchases

(76) Inventor: Rajul Johri, West Jordan, UT (US)

(21) Appl. No.: 13/589,159

(22) Filed: Aug. 19, 2012

Related U.S. Application Data
(63) Continuation-in-part of application No. 12/960,497, filed on Jan. 4, 2011.

(51) Int. Cl. G06K 7/01; G06Q 30/02; G06Q 20/22

(52) U.S. Cl. 705/14.58; 235/380; 705/35

(57) ABSTRACT

Payment systems currently in vogue (credit/debit cards) use a form of identity applicable only to a specific payment network (card number). This prevents the aggregation of one's payment options, and exposes the sensitive account information to the relatively insecure parts (merchant locations) of the transaction chain.

This invention introduces an alternative platform for payments by aggregating the different identities under one. It proposes to use one's cellphone number as that identity. A set of configurable rules defined by the user let him/her choose the appropriate method of payment at the point of sale. The invention is a set of software and hardware components that work together to create a secure, robust and easy-to-use payment system. It also allows for fraud detection at the time it is being committed.

The advantage of this system is that it lets the users pay for their purchases only using their mobile phone.

### STATEMENT

This continuation-in-part application claims the benefit of non-provisional application Ser. No. 12/960,497 (filed on Dec. 7, 2010) which is entirely incorporated here in by reference.

### TECHNICAL FIELD AND INDUSTRIAL APPLICABILITY OF THE INVENTION

This invention relates to the use of mobile devices for making payments for store and web purchases

### BACKGROUND OF THE INVENTION

Credit cards have been around for nearly five decades (starting in 1950 with Diners Club) in the same form and seem to have missed the latest developments in technology. They have largely remained resistant to change in form (plastic card, rectangular shape etc.) and function (making payments).

There has been a flurry of activity recently in the payments industry to allow users to use different types of devices to make the payments. Most prominent amongst them are RFID enabled tags (which can be attached to mobile phones). All of these devices create a new ID (associated to the RFID device) in place of the credit card number and at the payment network, associate it with the credit account of the user. When the user brings these devices in close proximity to the reader at the checkout, this ID is transmitted wirelessly and the transaction is authorized against the credit account of the user.

The focus of all these new forms is the payment network. All these new forms are targetted to drive users to one or the other network. There is little effort to aggregate these different networks and let the user chose whichever network they wish to use for their payments. There is another kind of aggregation that is needed at the checkout. That is for the coupons/discounts that a person can use for the items purchased.

The current invention attempts to create a system which will do the aggregation discussed in [0005]. It will segregate the network identity of the user (their credit account) from their own identity. It will redefine the role of one's cellphone/mobile number as the core of ones identity. Use of the cellphone number instead of a complicated random large number is much easier for the user and allows for creating a payment-network-neutral ID. This ID can be associated to the different payment networks, the user is associated with. This same ID can be associated with all the discounts a person is eligible for and can be applied electronically.

There are obvious security issues with using a common ID such as ones cell phone number for purchases. The invention addresses all these security concerns in its design and in effect creates a system that is much more secure than any other alternative. It uses the two-factor authentication and allows for even three-factor authentication(what a person is, what a person has, what a person knows).

### DETAILED DESCRIPTION OF INVENTION

Introduction

Credit cards need a makeover. They have been around for nearly five decades (started in 1950 with Diners Club) in the same form and seem to have missed the latest developments in technology. They have largely remained resistant to change in form (plastic card, rectangular shape etc.) and function (making payments). This resistance was justified even few years ago before mobile phones became prevalent. Then, a plastic card was the smallest form factor a person could carry with them that could convey their identity to a merchant. It was also not possible to verify that identity with a trusted third party without the phone line based POS systems. This is not the case today. Not only do people carry a device (mobile phones) with them that uniquely identifies them (mobile numbers are unique, just as a credit card number) but this device is capable of communicating voice and data. So, ideally one should not need a credit card to convey their identity. It should be possible for merchants to charge one's credit/charge card account by knowing just their phone number.

There is no current system that allows users to complete their purchases using their cellphone numbers. This document describes a new system (LivewirePay) that will allow users to pay for their purchases only using their mobile phones or other such devices that uniquely identify them and can communicate over the wireless networks. Not only will this system allow users to carry a lighter wallet (or no wallet) but also will let them make purchases using a number they can easily remember (their mobile phone number). Other than the usual identity management, this system will allow users to navigate between their multiple credit cards and other accounts.

Other Approaches And Their Limits

Some solutions in the mobile payment space are being attempted through RFID (Radio Frequency IDentification) tags inserted in mobile phones. These employ NFC (Near Field communication) technology to read data stored on the RFID tags. NFC works within a very small range (about 4 inches). Those solutions are mainly aimed at automating/speeding-up the checkout process. They use the RFID tags to establish the financial identity.

There are also some experiments being done to let users pay for their small online purchases using their mobile phones. In those cases, the phone company bills the purchase to the buyer on a monthly basis. These are a step in the right direction but they do not address the credit risk associated with a typical store transaction. In this model, Phone Company is the last entity left with credit risk. While it works for small transactions, it cannot work for regular day-to-day credit transactions because phone companies do not have the infrastructure to evaluate or carry the amount of credit risk inherent in regular credit transactions.

These approaches are payment network focused and are trying to address the mechanics of data exchange for a given network. Many of them are not inter-operable. For example, RFID tags provided by one network (say VISA) will not be applicable to another (say American Express). A system is needed that could aggregate various payment identities. The proposed system (LivewirePay) is one such system. It is customer focused and segregates the personal identity of the user (their phone number) and the payment network identity. It aggregates various payment network identities under the personal identity of the user. It identifies the importance of credit risk underlying this data exchange. The system can be built over the existing credit under-writing infrastructure. Issue of credit risk can be by-passed by attaching a checking account to the phone number.

The LivewirePay System Description

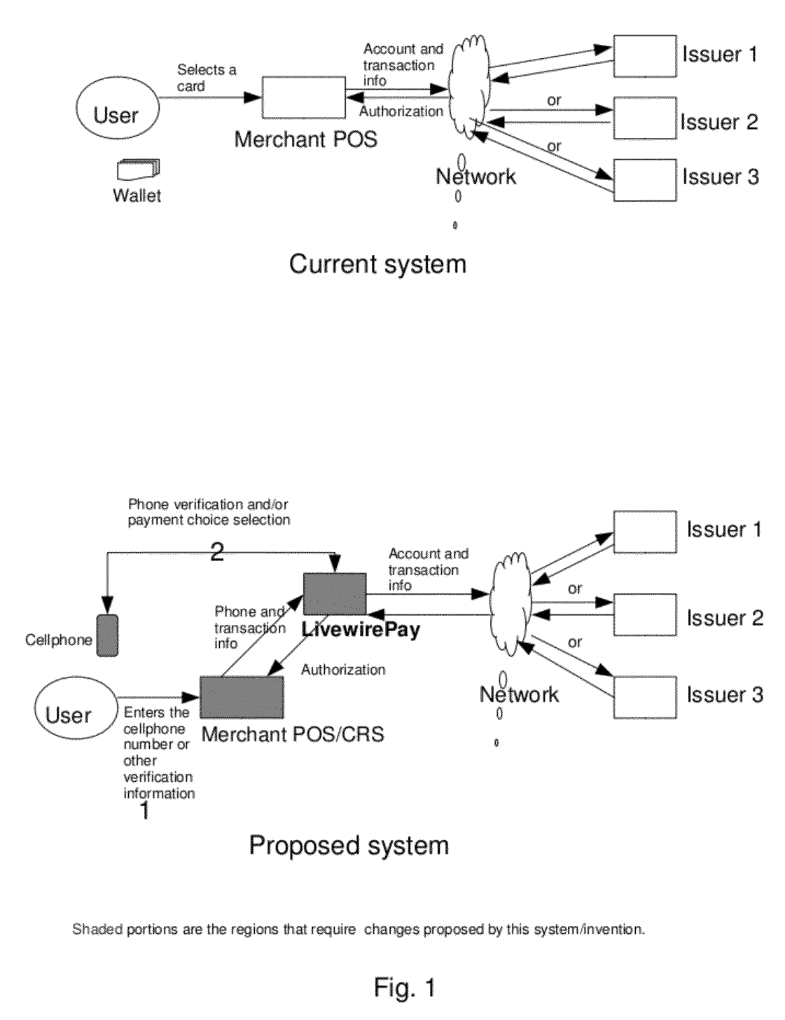

The LivewirePay system is software (see FIG. 1) that resides on the Internet and interacts with the following entities
Merchant's POS system or a machine (merchant module) in close proximity to the POS
User's (purchaser) mobile phone
Credit issuer's authorization system or ACH system for debit payments
User personally over the web

Inside LivewirePay's secure database, the user's phone number is associated with one or more validated payment methods (credit card, checking accounts etc). The system stores user's preferences for financial incentives (rewards, minimize interest payments, delay cash outflow etc) and assigns a numeric weight to each. Payment method attributes are identified which contribute to each preference. Each payment method is scored according to its different attribute values. An aggregate metric (relevancy score) is calculated for each payment method, that fairly represents all of user's preferences in a comprehensive manner. The payment method with the highest score is used. Here is an example.
Two users (1 and 2) have 3 credit cards (CC1, CC2 and CC3), with the features as in the table below. The numbers in parenthesis are the scores system gives them based on the different attributes. Highest interest rate getting the lowest score (1) and highest rewards getting highest (3) score etc.

| | Payment due date | Rewards | Interest rate |
|---|---|---|---|
| CC1 | Feb. 27, 2010 (3) | 1% (1) | 13% (2) |
| CC2 | Feb. 15, 2010 (2) | 2% (2) | 10% (3) |
| CC3 | Feb. 12, 2010 (1) | 3% (3) | 15% (1) |

The stated preferences (in decreasing order of importance) of users 1 and 2 are as below (the number in parenthesis is the weight for each preference)
User 1 Delay cash outflow (3)
   Minimize interest payments (2)
   Rewards(1)
User 2 Minimize interest payments (3)
   Rewards (2)
   Delay cash outflow (1)

Based on the above preferences, system calculates the aggregate metric (weighted product in this example) for each credit card. Relevancy score of CC1 for user 1 is
Σ User1's weight for a financial preference*CC1's score on attribute(s) associated with the preference
   e.g. User 1's weight for rewards (1)*CC1's score on rewards (1)+User 1's weight for delaying cash outflow (3)*CC1's score on payment due date (3) . . .

| | User 1 | User 2 |
|---|---|---|
| CC1 | 3 * 3 + 2 * 2 + 1 * 1 = 14 | 2 * 3 + 1 * 2 + 3 * 1 = 11 |
| CC2 | 2 * 3 + 3 * 2 + 2 * 1 = 14 | 3 * 3 + 2 * 2 + 2 * 1 = 15 |
| CC3 | 1 * 3 + 1 * 2 + 3 * 1 = 8 | 1 * 3 + 3 * 2 + 1 * 1 = 10 |

User 1 should use CC1 and User 2 should use CC2.

Notice that the scores for CC1 and CC2 for user 1 are tied (14). We use user 1's first preference to break that tie. User 1's first preference is to Delay cash outflow, so we select the credit card ranking highest on the attribute associated to this preference (payment due date).

Here is the transaction flow that enables LivewirePay to complete transactions (See FIG. 1)

Merchant→LivewirePay→User's mobile/Merchant→LivewirePay→Issuer's authorization system→LivewirePay→Merchant

LivewirePay receives a phone number and the transaction information (merchant, merchandise, category, quantity, price etc.) as the input. Upon receiving the information, LivewirePay validates merchant's identity and sends user's personal details to merchant's POS. Then it tries to authenticate the user's identity. The user may input their authentication information/PIN at the POS terminal. Alternatively, the authentication could be done using user's phone. Phone based authentication can be done either through Smart App, SMS, text, email or an automated voice response call depending upon the type of mobile device the user is carrying. The payment method is also confirmed at the same time. The actual account number of the user is never accessed before the financial transaction. The minimum possible information about the financial identity is sent outside the LivewirePay system (only last few digits of a credit card etc.). This minimum information is considered a part of personal information since it lets user indicate their choice of payment method.

The authentication process is multi-moded, in the sense that there is not one key or password alone. While there are a passkey and PIN number, there also are unique shapes, small puzzles and biometric data (finger print and Iris scans etc) that only the user can produce. The LivewirePay system utilizes this information to challenge the user while authenticating their identity. LivewirePay system does not send answers of the authentication questions out on the network (either to POS or to user's cellphone). It only sends question(s) and expects the answers back. It uses a combination of transaction history and the current context to chose one or more methods (PIN, question set, images etc) to authenticate the user. The system aims to strike a balance between the quickest and safest means of authentication appropriate for the circumstance. User can also chose a different account to charge during this authentication step. The LivewirePay system can store various coupons electronically and get those applied to the purchase in this step.

After user authentication, LivewirePay proceeds to authorize the transaction with the selected payment system (selected by the LivewirePay system or user's choice during authentication). Once the transaction is authorized, it returns an approval code to the merchant, who then prints the checkout receipt.

LivewirePay system can be created as a new system or as an improvement to an existing payment system. The following changes will need to be made to the existing infrastructure of payment processing (see FIG. 1)
Merchant's POS system will be altered to accept phone numbers and pass the transaction info along with the phone number to LivewirePay system.
LivewirePay system will be created that interfaces with the POS at merchant's premises, user's cellphones and with payment networks to authorize the transactions.
Users will register their phone number, authentication information, preferences and payment methods with the LivewirePay system over the web.
Merchant will register their details (account information, keys to authenticate, promotions etc) in the LivewirePay system. This information will be used to authenticate the merchat and provide merchant promotion offers to LivewirePay users.

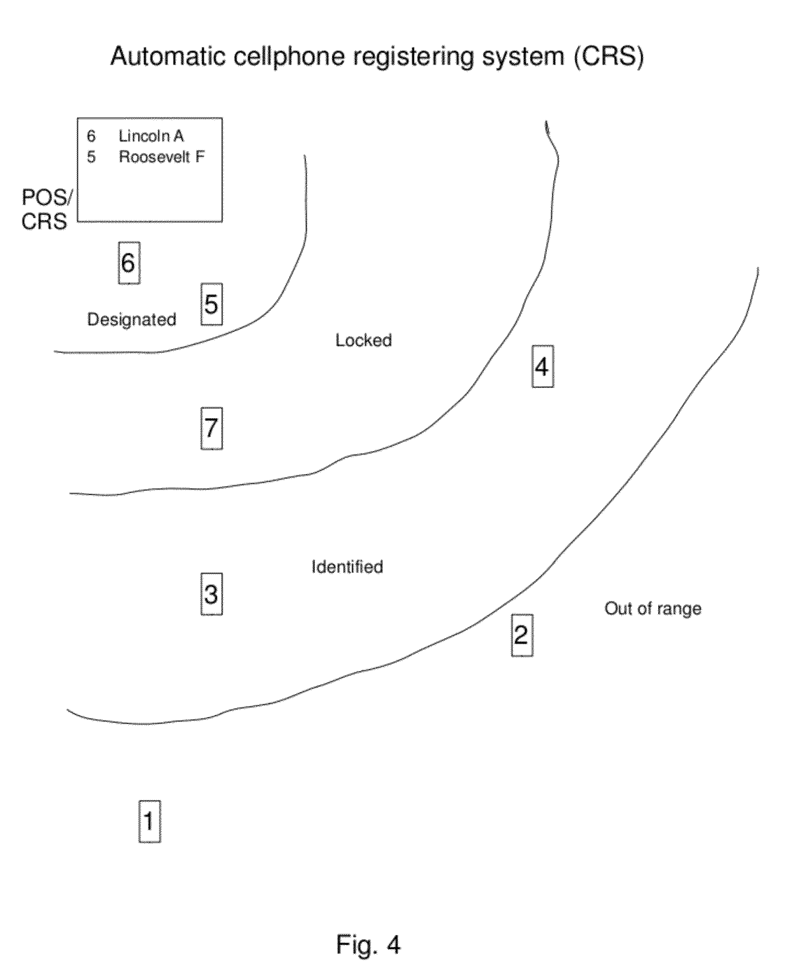

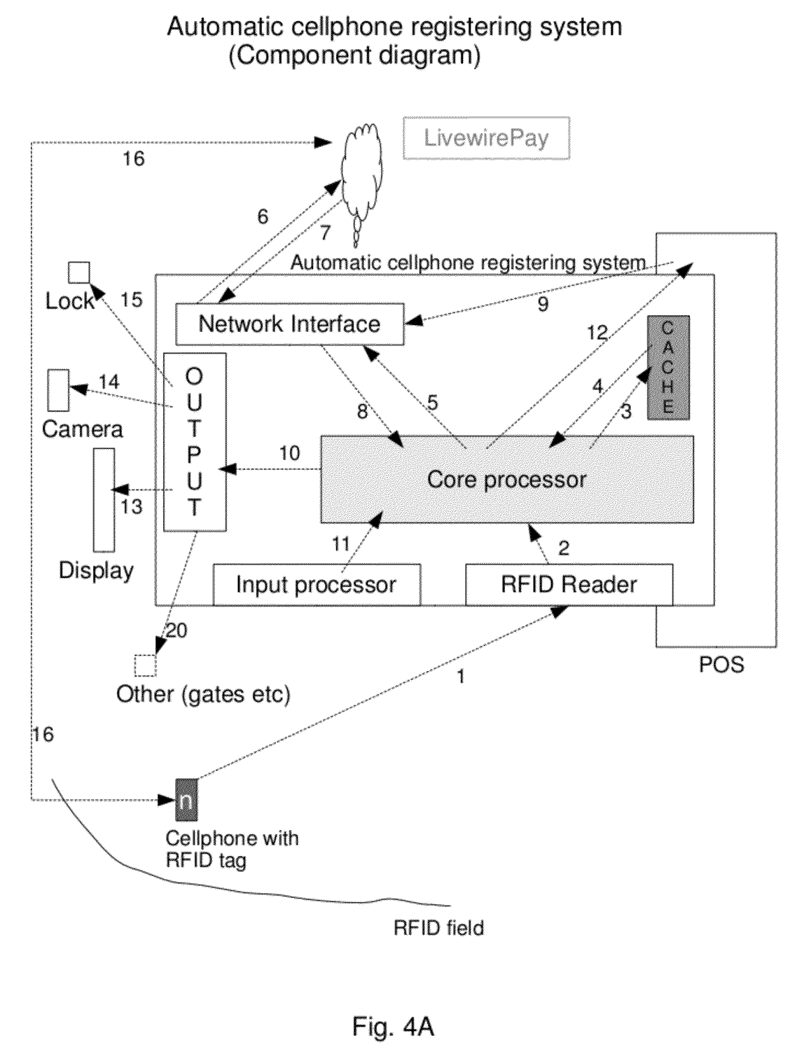

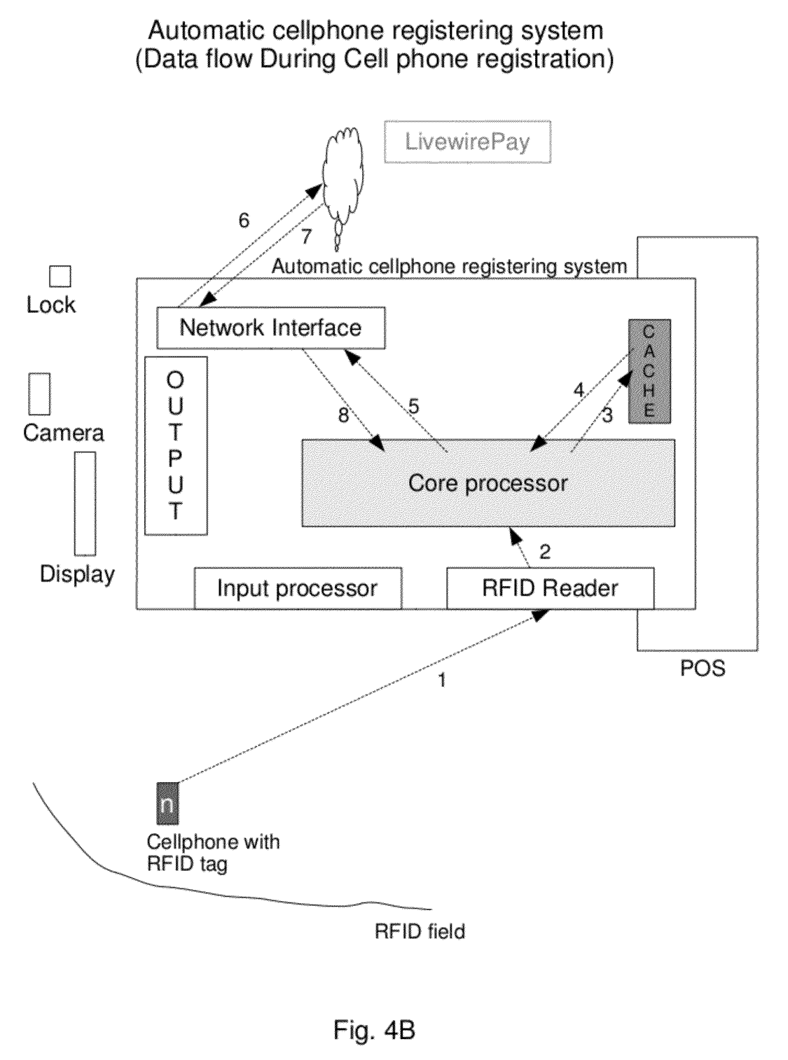

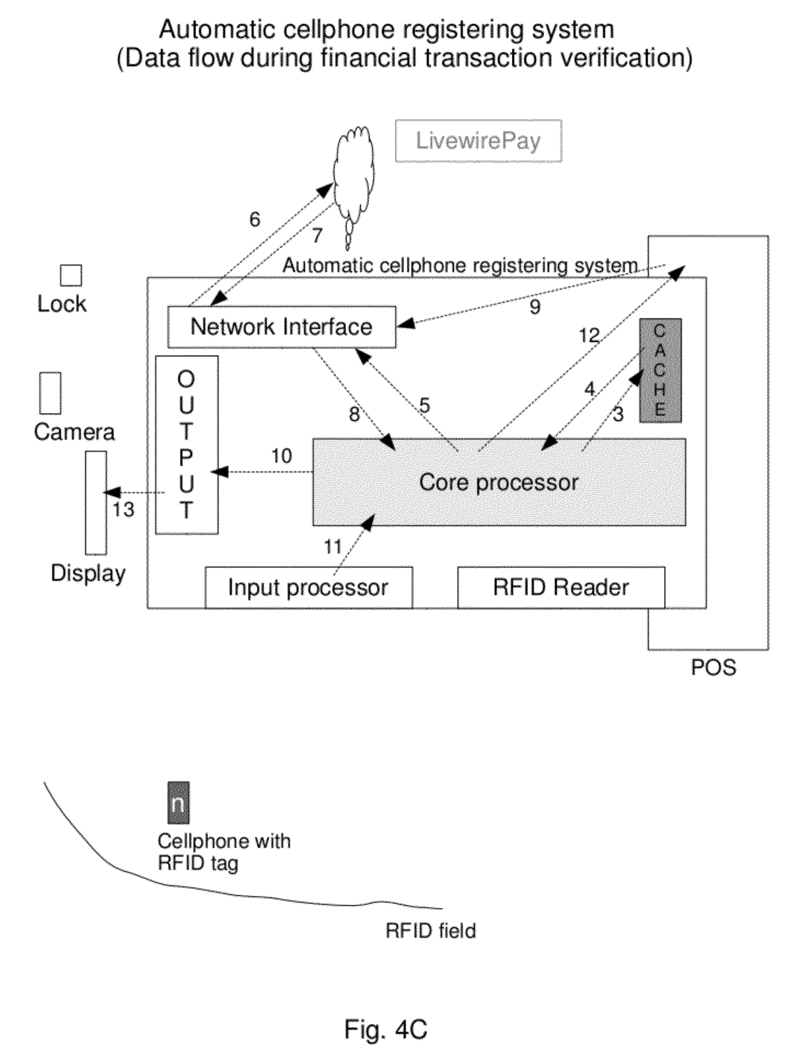

Other Features/benefits
LivewirePay will let users keep their credit cards safely at home. This will help avoid the scenarios where hackers are able to get hold of credit card numbers of customers at a supermarket by hacking into the POS terminal. In this system, the sensitive information (credit card numbers, authentication information) never comes out on insecure networks.
LivewirePay will allow users to alert all the payment networks at the same time in case of a breach.
LivewirePay will allow users to track their expenses on all their accounts in one central location.
LivewirePay could also grow large enough so that credit cards become virtual, thereby reducing the use of plastic.
The POS system can be equipped with a camera capable of taking the picture of the person doing the transaction. The camera is triggered (see FIG. 4A) when the LivewirePay system returns a specific code. The LivewirePay system can invoke the camera by returning an appropriate transaction return code. The picture taken is sent to the LivewirePay system which stores it along with other transaction information. Some instances where this may be appropriate are:
   First transaction on an account
   Multiple attempts to enter PIN
   Failed transaction
   User defined (e.g. User may want the picture for every transaction greater than $100).

### SUMMARY

LiveWirePay is an easy, robust and secure method to allow users to make purchases and pay for them using just their mobile phone number. In addition to the ease of use, this solution allows users to make their purchases across different payment methods (credit cards, checking accounts etc) according to their preferences.

The main idea here is to securely authenticate the user first and only then access their payment network identity. The current credit and debit products merge the two problems. They access the user's payment account directly through the swipe of a card. They assume that the person swiping the card is the user. The two processes (identify the user and complete the transaction) need to be segregated. The advent of mobile phones and the easy availability of computing power and network access make such a segregation of concerns not only desirable but possible.

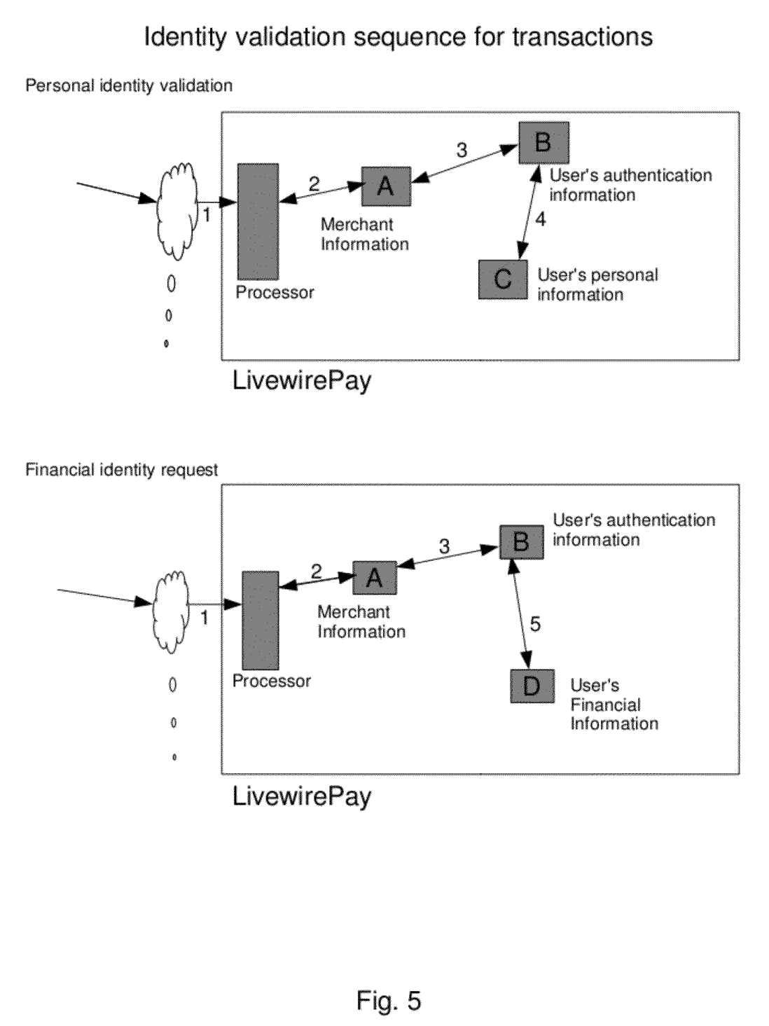

One way to implement such a system (of separating concerns) is by keeping user's personal, authentication, financial and transaction information separate and accessing it in sequence (FIG. 5). There exist many possible combinations of storing this information (personal and authentication information in one database and rest in others etc.). The key is to access this information only in a sequence (personal information should be looked up after validating merchant, financial information should be looked up only after validating merchant and user).

The possibility of employing multi-factor authentication (using something user has, something user knows and something user is) for LivewirePay system makes this an ideal system for applications where such authentication may be necessary. In this system, in order to complete a transaction, the user needs to HAVE the cellphone, KNOW their personal key/answer etc and BE the person (whose name/picture appears on the POS) to authenticate their identity.

We have thus far described a system where the user explicitly provides the merchant with their phone number or another unique ID, which is separate from their financial identity (account number). The system uses this ID to identify and authenticate the user. Only after authenticating the user, the system conducts a transaction using appropriate financial identity. The rest of the document describes a way to eliminate the step of explicitly providing the unique ID to the merchant. It proposes a method of detecting this unique ID from a distance. This other mode (automatic cell-phone registration) makes the system more user friendly and much more secure.

### Automatic Cellphone Registering System (CRS)

The LivewirePay system will also include an automatic mode of cellphone number detection. In this mode, the automatic identification of phone numbers (or another unique ID) will ensure that the correct device/phone is used to make the payment. This mode will be activated if the user's cell phone has the LivewirePay RFID (Radio Frequency IDentification) tag attached in (embedded with) the cellphone and the merchant has a POS terminal or a separate module (CRS) equipped with the RFID reader running LivewirePay protocol. CRS is a machine which communicates with the RFID tag, the POS and the LivewirePay system to create a seamless experience of transaction processing (see FIG. 4A).

RFID tag is one of the means of reading the cellphone number over a distance. RFID uses radio frequency electromagnetic fields to transfer data from a tag to the reader. The data stored in the tag is transmitted wirelessly when the tag comes in the range of the reader. The same could be done using other wireless technologies like IR, bluetooth, ultrasonic communication etc. RFID is the ideal fit for this type of application, because it works without a direct line of sight between the tag and the reader and has a range of 100 meters (sufficient to provide meaningful distance for reads).

With CRS, the POS or merchant side module can detect the phone number of the user and initiate the call to LivewirePay automatically without any input from the user. We describe below a system and a protocol to identify the user based on just their cellphone number, read wirelessly over a distance.

A protocol is designed to distinguish the registered cellphone numbers from amongst a multitude of other cellphones that could be present around the POS. The protocol works not only with the phone number but ANY unique ID that may be associated with the mobile device as long as the ID is registered with LivewirePay. Phone number is the preferred ID though. Phone number makes for an easy identifier and the protocol ensures that the transaction environment is secure.

CRS System Description

Cellphone registering system (CRS) may be embedded within the POS system or kept in close proximity to the POS (see FIG. 4A) such that it can communicate with the POS. POS triggers the transaction that CRS applies to the appropriate user (selected from among those detected in range). It is possible to imagine a situation where the CRS could be kept far from the POS (say a hotel room, where CRS is embedded in each room's lock, but POS is at the front desk). The key is to know that it needs to communicate with a POS, which in most instances will be closeby. POS contains the transaction information and the CRS contains the user/transactor information.

CRS works by communicating with the RFID tag associated with (attached or located inside) the cellphone. RFID tag transmits the phone number to the RFID tag reader. The cellphone number is part of application data that gets exchanged between the RFID tag and the reader. This communication is fast and secure (application data/phone number is encrypted). RFID reader is designed to read the cell phone numbers within a predetermined radius of the POS/CRS. This radius could be modified by changing the RFID reader's field strength. It is possible for a CRS to identify multiple cellphone numbers present nearby. There is an additional protocol followed to sort the cell phones according to their distance from the CRS.

Once the system is able to successfully “Identify” (detect) a number in its range, it acquires a “lock” on that number (see FIG. 4). To acquire a “lock”, the reader will attempt to read a tag twice. If both attempts are successful, a logical “lock” will be deemed present. The CRS will then query the user's personal details (such as name, photograph, set of questions to authenticate user, applicable coupons, payment method etc) from LivewirePay system. If LivewirePay system can validate that the request came from a valid merchant and the user's information can be shared with the merchant, it returns this information to CRS. CRS also receives an authentication score from the LivewirePay system. After that, it will “monitor” the number. To “monitor” it will complete 10* consecutive reads. The number successfully monitored will be the “designated” phone number. The CRS could display**** or keep for further usage the nearest “designated” phone numbers (it will sort them in the ascending order of time taken to finish 10* reads).

Here are the various states a phone number goes through in this protocol. Each subsequent state (except for the ‘Excluded’) subsumes the previous one and follows in a sequence.
a) Identified This is a cell phone number the RFID tag reader is able to read successfully.
b) Locked This is a cell phone number which the RFID tag reader was able to successfully Identify in two successive trials. A given CRS may have more than one locked cell phones. The name/photo is queried from the LivewirePay system.
c) Designated This is a cell phone number singled out after successful locking in 10* trials. The time taken to complete the 10* trials is recorded and used to rank the users near the CRS. * The number of 10 trials for “designating” can be changed based on the merchant or CRS.
d) Excluded These cellphone numbers belong to the personnel of the store and never enter the above states.

The authentication score returned by LivewirePay system as part of the initial response, is a critical part of the system. Authentication score is a numerical value indicating LivewirePay system's confidence in the cellphone number belonging to the person carrying it. Different merchants could use different thresholds (possibly different for different CRS at the same merchant) to request a fresh authentication. If merchant receives an authentication score higher than their pre-determined threshold, the transaction goes through automatically, without any authentication step. Authentication score is a means to avoid user having to authenticate every time they want to transact. Here is a sample list of what different Authentication scores could mean

| | |
|---|---|
| 0-10 | New user, never authenticated |
| 10-20 | Authenticated within last month |
| 20-50 | Authenticated within last week |
| 50-70 | Authenticated within last week at the same store |
| 70-80 | Authenticated within last 24 hours |
| 80-100 | Authenticated within last 1 hour |

The use of an authentication score provided by a trusted system makes it possible for merchants to avoid authenticating a user who has already authenticated within parameters acceptable to them. After authenticating a user with a strong method (like biometric or multiple questions) the LivewirePay system returns the highest possible authentication score that decays with time and transactions. After a sufficiently long interval or after a number or type of transactions, without any further authentication, the authentication score becomes small enough that some merchant or LivewirePay system itself has to request a fresh authentication. The set of questions returned with the initial response also indicate the effect on authentication score their correct answers will have. CRS makes use of this data to select the appropriate question(s).

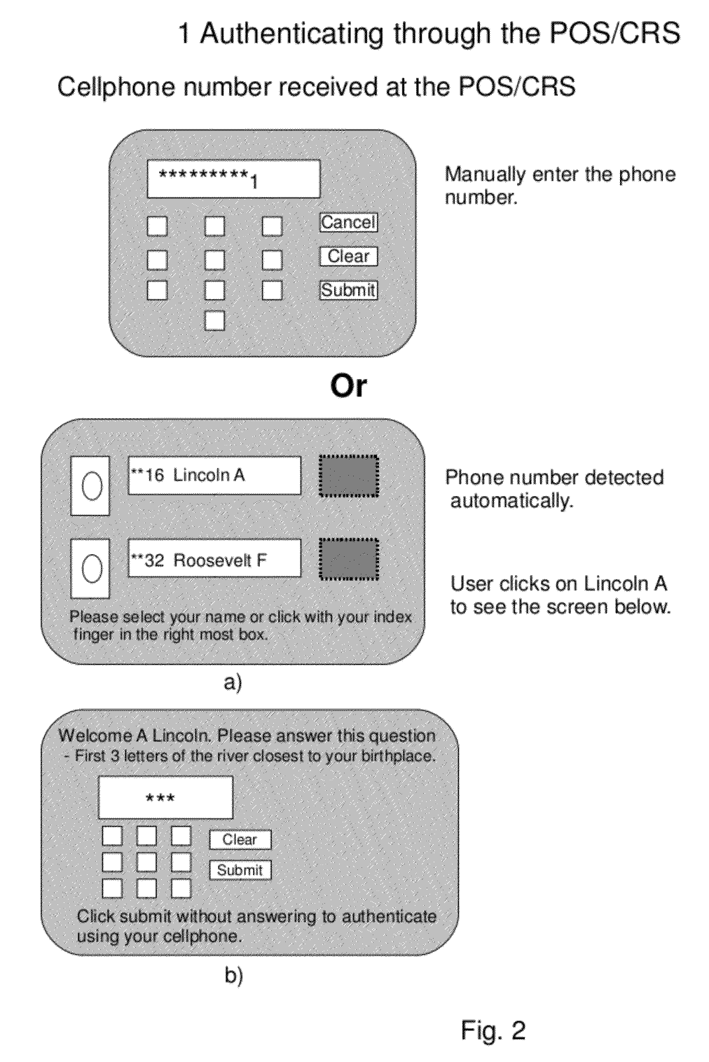

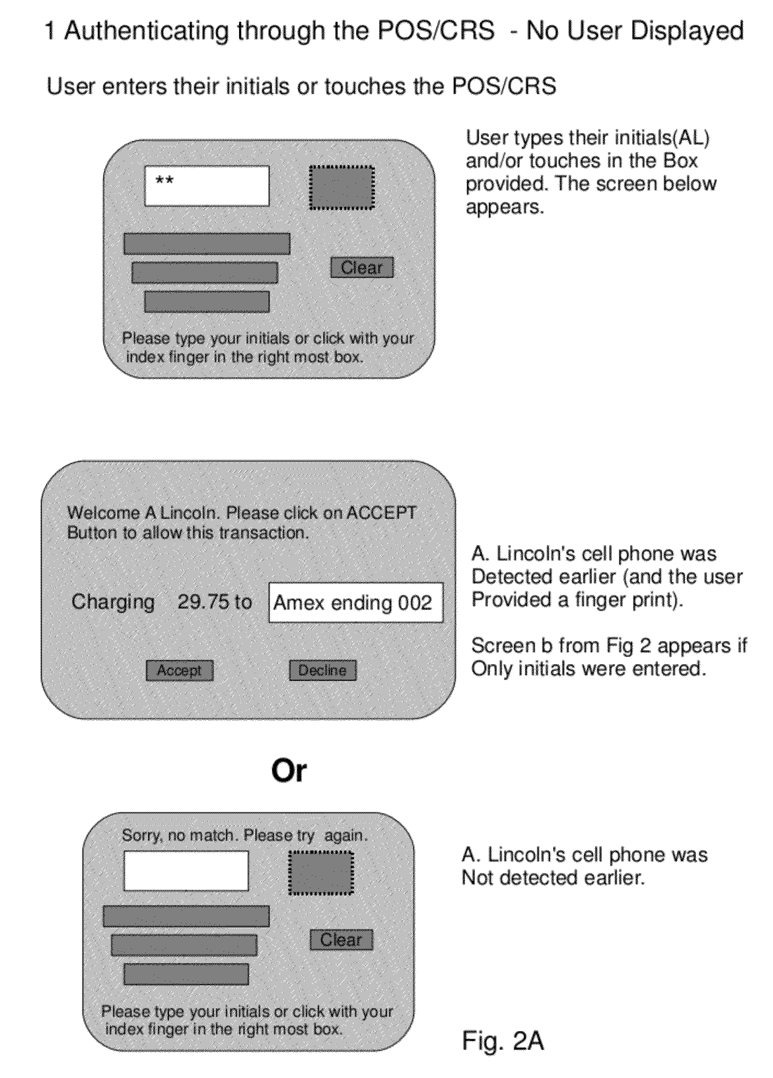

By this time, CRS has detected a user and stored the personal details of the user. Any time after this, when the checkout clerk has checked out all the items and pressed the check-out key, transaction information is passed to CRS, which applies it to the user. POS/CRS screen displays last few digits of the detected phone numbers along with the photographs/names. The buyer or checkout clerk touches the appropriate name or photograph. In case a photograph is used to validate the transaction, there will be no need for user to authenticate the transaction. The same is true in the case of a displayed name, which can be authenticated against the user's driving license. There may be an additional capability for the buyer to just touch the screen thereby authenticating with their finger print (FIG. 2). If a photograph/name was not returned by the LivewirePay system, the buyer can just click on the appropriate phone number and complete the transaction by authenticating through their phone.

Some POS/CRS may not display user's information even after detecting them. Examples are self checkouts and ATMs. In these cases, the POS/CRS will just store the information and the user will be expected to enter some information that matches the information already and stored within POS/CRS. The POS/CRS will display a message (e.g. Please enter your initials to start or Please touch with your Index finger to start etc.). The user enters their Initials and/or touches the screen. The POS/CRS checks whether the information for this user already exists (their cellphone has been detected within range) and upon successful match goes on to complete the financial transaction (See FIG. 2A). **** CRS system deletes a cellphone number some time after designation if there is no transaction. This period could be a couple hours. After a transaction, the cellphone number is deleted immediately, so that the next person in line has their name/data move up in CRS list.

### SUMMARY

The system described here for accessing the user's partial identity (cellphone number) is different from other RFID/NFC based approaches. There are two main differences, identifier used and the distance. Other approaches work by bringing the RFID tag very close (about 4 inches) to the reader. In those approaches, it is of paramount importance to be absolutely sure of the person closest to the POS terminal, because the identity stored in the RFID tag is the network identity (account) of the user. In that situation, the distance is kept very small to reduce the chances of error. In LivewirePay, since the personal identity is separate from network identity, we can afford to be lenient in the solution of this problem (finding the user closest to the POS). We do not have to know the user closest to the POS/CRS, because we are not transacting based on the identifier in the RFID tag. We just use the identifier (cellphone number) to find the personal details of the user and after getting those, we authenticate the user (using name, photograph, set of questions, finger print etc) before transacting. From a distance perspective, only problem we are interested in solving is finding the relative distance of users from POS/CRS. We are satisfied if we know that user A is closer to the terminal than user B.

This system is different from a Location based service, which identifies a person within a range of a specific geographic location based on the cellphone's GPS. Location based service requires much more computational rigour to achieve the point accuracy that is built into RFID approach by definition. Another difference is that Location based service has to know the location of the user at all times, in order to detect them at a specific location, which could trigger privacy issues. Privacy is not much of an issue with LivewirePay approach because the user is being detected upon entering a merchant's store.

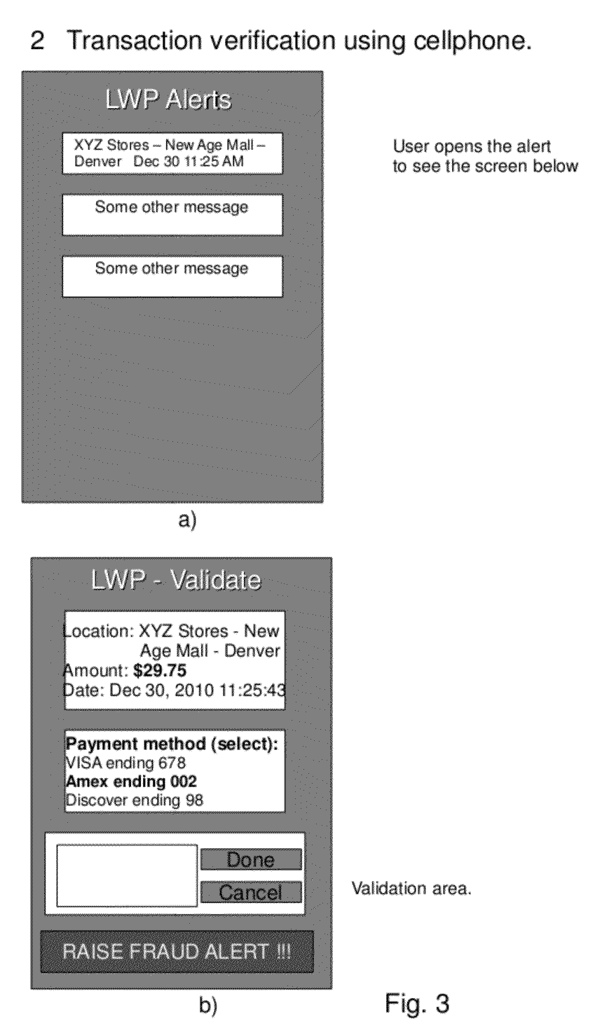

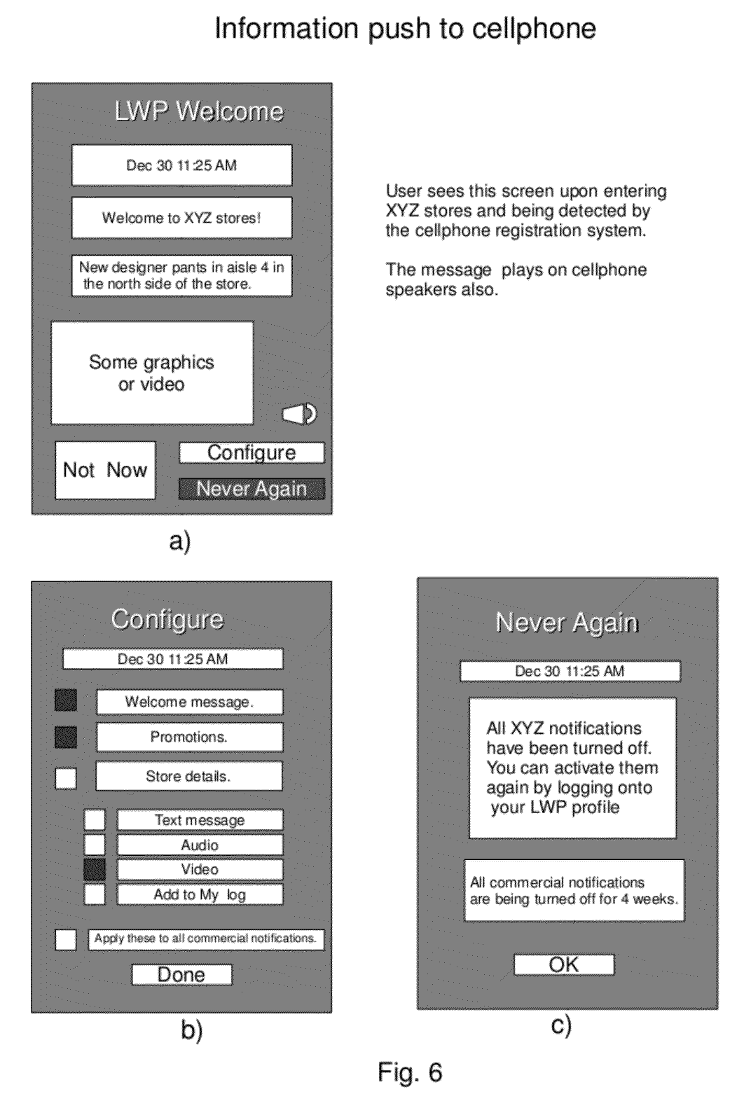

In LivewirePay, since cellphones can be detected by CRS over a larger distance, the scope of possible applications increases.
One obvious application is for merchants to provide tailored marketing promotions or efficient routing information (within their stores) to the user based on their prior purchases or preferences. These could be delivered in a “push” mode to the cellphone and can be audio-visual in nature (see FIG. 6).
Merchants could organize games for users who could automatically participate by just entering their stores.
Another is in toll-booth applications with the advantage being that the user need not bring their card/phone in close proximity to the reader. The readers in such applications are setup to only authenticate using the cellphone (FIG. 3), without a POS/CRS interface.

LiveWirePay system could also be used in a remote key application. In this manifestation, the CRS is embedded in a lock. The lock could be set to look for specific/configurable phone numbers (which become the keys to the lock). When the system registers the right phone number in proximity, it could open automatically or could initiate the authentication steps outlined earlier (See FIG. 3).

Another potential use of this system is in airline check-in at the gates. This system could detect LivewirePay registered cellphone numbers at the gate and check-in matching passengers automatically or after authentication.

### BRIEF DESCRIPTION OF THE SEVERAL VIEWS OF THE DRAWING

FIG. 1—Comparison of current and proposed payment systems.
In the current system user's account information (credit card number etc.) travels from user to the issuer and back. Authorization information travels from issuer to user.
Identifies the areas (shaded) of current payment system that will be impacted by LivewirePay system
   POS at the merchant (either through direct modification or through a separate CRS)
   Cell-phone of the user
   A new web-based LivewirePay system
In LivewirePay system, user's account information remains on the more secure private network.
Sections marked 1 and 2 in the proposed system area are described in more detail in FIG. 2 and FIG. 3

FIG. 2—Manual and automated methods of supplying ID to LivewirePay system
Top area of the figure depicts the manual ID entry screen at the POS/CRS
   In this mode, user does not get the option to enter the PIN. This mode is for online transactions or for the stores that do not have the CRS installed. It may be possible to have stores keep the option of manual entry of PIN, but online transactions have to have the cell-phone verification.
Bottom area (below the literal ‘Or’) features screens that system displays at the POS/CRS in the automatic cellphone registration case.
   Screen a) displays the cell-phones located by the system (through cellphone detection system). The system displays the users in the order of their distance from the CRS. It is possible to correct an error made by the system in detecting the relative distance. In the figure, the system found Lincoln A to be closer to the CRS than Roosevelt F. If it is indeed Roosevelt F that is doing the transaction, then user can select second name instead of the top one identified by the system.
   The system allows the checkout clerk to click on the photograph of the buyer to authorize the transaction. Clicking on the photo completes the authentication and screen b) is not displayed. In cases where the POS/CRS is facing the buyer, the option to click on the photograph is disabled.
   The system also lets users provide their finger print for authenticating their identity. They can touch the box in front of their name to do that. Screen b) is not displayed in such cases also.
   Screen b) lets the user enter their PIN or authenticate their identity by answering the challenge question. Once the user clicks Done on this screen, they see their transaction information, which they accept and complete the transaction.

FIG. 2A—Alternate mode of authenticating through POS/CRS
These figures correspond to automatic cellphone detection case where CRS does not display the users within range
   In this mode, user's finger print or their initials are used to identify them. In case of their finger print matching an already detected user's print, the transaction is displayed and approved (2^{nd} screen in FIG. 2A).
   If initials are used and matched with an automatically detected user's initials, the system displays the screen b of FIG. 2 and proceeds to authenticate using another method.

FIG. 3—Transaction verification using cell-phone
Screen a) shows the Inbox of the LivewirePay application on user's cell-phone
   User gets an alert message on their cellphone running the LivewirePay smart application. The Alert contains some identifying information about their current transaction.
Screen b) shows the transaction detail screen which user sees once they select their current transaction.
   The information on this screen comes from the information (such as the payment methods in their order of preference or according to the rules engine's output) the user provided while setting their account on LivewirePay website.
   In the example shown in the figure, the LivewirePay system selected the payment method automatically and highlighted it (below “Payment Method (select)” literal). The user may chose a different method. In some cases the system can insert some fake method(s) in order to more vigorously authenticate the user.
   The area next to literal “Validation area” is where the user provides the authenticaton information (a PIN number, a passkey, chooses one amongst a few pictures or bometric information) and presses Done to indicate their validation.
   The last button on the screen is the “Raise Fraud Alert” button. The user clicks this button if they do not recognize this transaction. It sends an alert in the middle of the transaction. This feature amongst others makes LivewirePay a really secure system. Upon receiving this alert, LivewirePay system takes mitigation steps to secure the user's identity, alert merchant and possibly law enforcement also. Notice that all this happens when the transaction is still active.

FIG. 4—A schematic of automatic cell-phone registering system.
The registering system (CRS) is embedded within the POS or communicates with the POS and with the RFID tag (or any other wireless communication method) in the cellphones (numbered 1-7). Once a phone is Identified, it queries the name of the person from LivewirePay online system.
Here is a status of all the cellphones within the registering system based on the layout in FIG. 4. Last column contains the times in milliseconds it took for the system to finish 10 complete “lookups” of designated cellphones. This is the number used to rank the cellphones (less time means closer to POS/CRS and hence ranks high). Multiple lookups are done to even out the random fluctuations in one lookup.

| | | | | |
|---|---|---|---|---|
| 1 | | | | |
| 2 | | | | |
| 3 | Identified | | | |
| 4 | Identified | | | |
| 5 | Identified | Locked | Designated | 765 |
| 6 | Identified | Locked | Designated | 583 |
| 7 | Identified | Locked | | |

FIG. 4 A—Component and data flow diagram of Automatic cellphone registering system
The registering system is embedded within the POS or kept in close proximity to the POS.
The Registering system consists of
   RFID reader—to detect RFID tags in its range (could be an IR receiver or Bluetooth sensor)
   Core processor—the main computing unit to handle all logical operations
   Network interface—to communicate with web based LivewirePay system and POS. If the registering system is embedded in a POS, POS directly interfaces with the core processor.
   Cache—a small local datastore to hold data specific to the merchant, device (there could be multiple devices at a single merchant), transaction and RFID tags identified
   Input processor—to accept touch or keyboard input from the user. Also used to receive captured image data from camera.
   Output handler—to display the information passed by Core processor or activate peripherals as required by the requirement (e.g. camera, locks, gates etc).
The data flow between these components during different usage scenarios is as follows.
Scenario 1—Data flow during cell-phone registration (see FIG. 4B)
   1—RFID tag is detected.
   2—Tag data is sent to core processor which decrypts the data, extracts the cellphone number/unique ID
   3—Core processor queries cache for this phone number
   4—Cache returns the data associated with the cellhone number or just stores it if it is a new cellphone number
   5—If it is a new cellphone number, core processor passes this to network interface.
   6—Network interface passes this cellphone number to web based LivewirePay system.
   7—LivewirePay system returns the personal data (name, photograph, set of questions, authentication score, applicable coupons etc) associated with this cellphone number, if LivewirePay can validate the merchant information and it is allowed (by user's settings) to return it, back to Network Processor.
   8—Network processor receives this data from LivewirePay and passes it to Core processor.
   3—Core processor saves the user's data in cache.
   Now, CRS has the personal data (name, photograph, authentication score, set of questions etc) of the person, which it can use to authenticate the user.
Scenario 2—Data flow during financial transaction verification is as follows (see FIG. 4C)
   9—The POS sends the transaction data (amount, items, time etc.) to Network interface after either the check-out clerk or user pressed checkout button on POS.
   8—Network interface passes this data to Core processor.
   3—Core processor saves it in cache.
   10—Core processor passes the information of the users (names, photographs etc) identified near the POS/CRS to be displayed on the screen. If the POS/CRS is not supposed to display the usernames but expected to authenticate first (FIG. 2A), then it sends a prompt to the screen through flow 13.
   11-1—If the POS/CRS displays a list of names and/or photographs, user selects her name from among those displayed on the screen. The information is passed to Core processor.
      3—The Core processor receives the cellphone number with the information and passes the cellphone number to cache and instructs it to attach this cellphone number to the transaction information saved in step 9 above.
      4—Cache returns the transaction information to Core processor which, after applying applicable coupons, passes it to display through flow 10, 13.
   11-2—If the POS/CRS displayed a prompt to enter her inititals and/or finger-print and only initials are passed to Core processor, it looks for names in the cache matching those initials. If a match is found, then Core processor sends the authentication question for the associated cellphone to the display through flow 10, 13.
      11—The user's response is passed to Core processor.
      5—Core processor passes this to network processor and gets the response authenticated through flow 5, 6, 7, 8.
      3—If the user is authenticated, Core processor passes the cellphone number to cache and instructs it to attach this cellphone number to the transaction information saved in step 9 above.
      4—Cache returns the transaction information to Core processor which, after applying applicable coupons, passes it to display through flow 10, 13.
   11-3—In case a prompt was displayed and user passed only her finger-print.
      5—Core processor passes this finger-print and all the cellphones detected near the

POS/CRS to Network Interface.
6Network processor passed this data to web based LivewirePay system.
7—LivewirePay system sees if the passed finger-print matches those in its record for the passed numbers. If it finds a match, it returns the matched cellphone number and an authentication score indicating that the user has been authenticated.
8—Network interface receives this data from LivewirePay and passes it to Core processor.
3—Core processor passes the cellphone number to cache and instructs it to attach this cellphone number to the transaction information saved in step 9 above.
4—Cache returns the transaction information to Core processor which, after applying applicable coupons, passes it to display through flow 10, 13.
Now CRS has authenticated the user and successfully displayed the transaction information to the display.
User acknowledges this transaction through flow 11 and system authorizes it using flow 5, 6, 7, 8, 12, 10, 13.
Scenario 3—Data flow during user authentication using cellphone.
   1—RFID tag is detected.
   2—Tag data is sent to core processor which decrypts the data, extracts the cellphone number/unique ID
   3—Core processor queries cache for this phone number
   4—Cache returns the data associated with the cellhone number or just stores it if it is a new cellphone number
   5—If it is a new cellphone number, core processor passes this to network interface.
   6—Network interface passes this cellphone number to web based LivewirePay system.
   7—LivewirePay system finds that either the user, merchant or CRS device profile requires cellphone authentication for this user. LivewirePay returns the personal data of the user and an authentication score indicating phone based authentication to Core processor using flow 7, 8.
   9—POS sends the transaction information to network Interface which passes it to Core Processor using flow 8.
   5—If there is only one cellphone detected near the POS/CRS, it is automatically attached to the transaction. Core processor sends the transaction information along with authentication request to network interface which passes it to LivewirePay using flow 6.
   5—If there are multiple cellphones detected near the POS/CRS, then Core processor resolves it to one cellphone using flow 10, 11 as described in Scenario 2 above. Core processor sends the transaction information along with authentication request to network interface which passes it to LivewirePay using flow 6.
   16—LivewirePay authenticates the user through her cellphone using flow 16.
   7—Upon successful authentication, it sends an authentication score indicating that the user has been authenticated to Core processor using flows 7, 8.
   Now cellphone detection system has authenticated the user.
Scenario 4—Data flow during data push to cellphone after identification (described in summary)
   1-2-5-7-16

FIG. 5—User's personal and financial identities can be treated separately. The figure shows the path taken by personal and financial identity requests in the LivewirePay system depicted in FIG. 1.
Separate information is stored in separate databases (named A, B, C and D) and access is controlled.
   Storing merchant information (their merchant ID, access levels, keys etc) in datastore A and opening restricted access to it over the network.
   Storing authentication information (mobile device numbers, personal PIN, question answer sets, passwords, picture choices, biometric data and other information required to authenticate a personal identity) in B and allowing access to this store only from datastore A upon a valid merchant request.
   Storing personal information (name, addresses, age, photographs and other personal information) keyed to their mobile device number in C and allowing access to this store only from datastore B upon a valid merchant request.
   Storing financial identity information (credit cards, account numbers) in D and allowing access to this store only from datastore B upon validation of a personal user PIN.
Financial identity request follows the same path as personal identity request except the last step (5).
Merchant's identity is validated first (step 2).
User is authenticated (step 3) next. This information is gathered as described in FIGS. 2 and 3.

FIG. 6—An example of sending information to the user's cellphone in a “push mode”. The figure shows the screens on the users cellphone after their cellphone has been detected at XYZ Stores.
Screen a) depicts the welcome screen with options to configure and turn off such notifications.
Screen b) allows users to configure all commercial notifications. They can choose to get only text, audio or video notifications. These settings do not affect “non-commercial” notifications such as airline checkins, toll-booth, emergency etc. There is an option to add specific information to “My Log”. A user can choose to receive promotions only and request those to be added to their “My Log”. Their log becomes a running history of their commercial activity. The coupons stored in their log can be searched at the time of checkout and applied automatically.
Screen c) displays the confirmation message when user selects “Never Again” on screen a). This turns off all promotional messages from XYZ stores. The system learns from the user's behaviour. If it notices a user turning off 3 consecutive notifications, it automatically turns all commercial notifications off for a period.

### LEGENDS

POS Point Of Sale system (the box used to swipe cards when making purchases)
Smart App An application running on user's smart phone
SMS Short Message Service
Authentication score A numerical value indicating LivewirePay system's confidence in the cellphone number belonging to the person carrying it.
CRS Automatic Cellphone Registering System [merchant module of LivewirePay]
NFC Near Field Communication
IR Infra Red
RFID Radio Frequency Identification
GPS Global Positioning System

What is claimed is:

1. A machine to detect a mobile device equipped with an RFID tag within a configurable distance, identify the owner of the said device, store the said owner's personal details(name, photograph etc) within the said machine, display the selective personal details of the said owner on a display and subsequently authenticate the said owner, comprising:
An RFID reader of required read range.
Network interface communicating with a web based trusted datastore and other nearby electronic devices.
A local database storing state information of various transactions.
Touch screen receiving touch input from the user including alphanumeric or biometric data (finger prints etc)
Core processor processing the data received from all the attached devices and exchanging the data between different components of the said machine, including reading/decrypting the data containing the said unique number from nearby RFID tag(s), exchanging the unique number and additional information with a web based trusted datastore and receiving the response from the said datastore.
Output processor sending the output of the said machine to a peripheral device such as a display or any other electrical/mechanical system whose activation is dependent on a specific person appearing within range of the said machine.
A camera taking the picture of the person in front of it upon receiving instructions from the output processor.

2. A method to identify a person from a distance by using a unique number read from a wireless device carried by the said person and authenticate the person to conduct a transaction, comprising:
Wirelessly detecting a unique number stored in a wireless device carried by a person through a different electronic device and storing the said number in the electronic device.
Transmitting the said unique number to a web based trusted datastore containing the said person's information associated with the said unique number.
Receiving the personal information (including name, photograph, an authentication score and a set of questions without answers) of the said person, in response to the previous transmission and storing this information in the said electronic device
Using the said personal information to authenticate the said person subsequently, including, by presenting the said person with one or more of the said questions, receiving the answers from the said person, sending the answers to the said datastore and using the returned authentication score from the said datastore to authenticate the said person.

3. A method to choose from among different payment methods (credit card, debit cards etc) provided by a user, based on the user's preferences for financial incentives, comprising:
Receiving and storing in an electronic datastore, the user's preferences for financial incentives (e.g. rewards, minimize interest payments, delay cash outflow etc) in user's order of preference, giving them a numeric weight.
Identifying one or more data attributes among different payment method attributes (credit limit, payment due date, interest rate etc) those which directly contribute to the user's preferences.
Scoring each identified attribute of the payment method according to their values.
Calculating an aggregate metric by using the payment method data attribute score and the user's weights for financial incentives.
Selecting the payment method with the highest value for the aggregate metric.

4. A method to automatically receive offers, coupons or other promotional material in an electronic form from merchants by walking in or walking by stores, comprising:
The merchant storing their promotions in a web based trusted datastore.
An electronic device within the merchant's store detecting the user's unique number stored in a wireless device, when the user comes within the said device's range.
The said device passing this unique number to the said datastore and requesting for applicable coupons, either based on user's personal history or otherwise, to be sent to the user.
The said datastore storing the promotions to user's profile already stored in the said datastore and sending a confirmation to the user on their wireless device.
